(19) United States
(12) Patent Application Publication
(10) Pub. No.: US 2009/0265041 A1
(43) Pub. Date: Oct. 22, 2009

(54) Power Distribution and Monitoring System

(76) Inventor: Daniel E. Benjamin, Los Angeles, CA (US)

Correspondence Address: STETINA BRUNDA GARRED & BRUCKER, 75 ENTERPRISE, SUITE 250, ALISO VIEJO, CA, 92656, US

(21) Appl. No.: 12/426,132

(22) Filed: Apr. 17, 2009

Related U.S. Application Data
(60) Provisional application No. 61/046,377, filed on Apr. 18, 2008.

(51) Int. Cl. G06F 19/00; G06F 11/30

(52) U.S. Cl. 700/292; 702/188

(57) ABSTRACT

In accordance with the present invention, there is provided multiple embodiments of systems and methods monitoring a power system. The system and methods provide a robust and comprehensive monitoring system to accurately assess system performance and identify system interference and power failures. The system is designed to capture parameters capable of being monitored in a power distribution system, such as voltage, current, temperature or the like. A basic embodiment of the present invention includes at least one line monitor for measuring electrical parameters on the line side of a power system, a load monitor for measuring electrical parameters from the load side of a power system, a control panel for compiling the data, and a remote server for providing further analysis of the system and monitoring the system in real time.

### CROSS-REFERENCE TO RELATED APPLICATIONS

This application claims priority to Provisional Application No. 61/046,377 for Power Distribution and Monitoring System filed on Apr. 18, 2008.

### STATEMENT RE: FEDERALLY SPONSORED RESEARCH/DEVELOPMENT

Not Applicable

### BACKGROUND

1. Field of the Invention

The present invention relates to a power distribution and monitoring system, and more particularly to systems and methods for distributing power and remotely monitoring power quality and precisely identifying the root cause for power failures in an electrical power distribution system.

2. Description of Related Art

Electrical power distribution systems distribute power to various loads and are typically divided into branch circuits, which subsequently supply power to specified loads. Additional branch circuits may be utilized to supply power to various distribution systems. In order to protect the circuit for irregular power supplies, circuit breakers are commonly used for temporary interruption of electrical power to electrical devices (loads).

Modern circuit breaker systems utilize a plurality of circuit breakers for programmable control of lighting and other loads in commercial and industrial applications. Selectively opening and closing the various circuit breakers in a system provides energy savings and ease of operation over manually operated circuit breakers.

Oftentimes, robust monitoring of power systems allows for optimal performance of the power distribution system as a whole. The reliability of a power system may be significantly deficient relative to the original design if the system is poorly maintained. As a result, it is critical to recognize and identify common problems present in any power distribution environment. Such common problems include: power failure, power sag, power surge, under voltage, over voltage, line noise, frequency variation, switching transient, and harmonic distortion. Nearly all industries and business rely upon successful and reliable power delivery. In this regard, critical systems and infrastructures require constant monitoring and vigilant management. Monitoring and data analysis, whether conducted on site or remotely, provide instant visibility, isolating problems and their causes so they may be resolved quickly. As a result, remote monitoring has become increasingly more popular due to low cost alternatives such as the Internet and wireless communications systems.

Currently, there are systems that remotely monitor electrical power distribution systems in the market. Including, the Entellisys System introduced by General Electric. However, the Entellisys system is understood to be applicable only to the head end of the typical electrical power distribution system and does not proliferate its capabilities throughout the entire system. Additionally, the prior art systems are understood to be further limited by the inclusion of current and potential (voltage) transformers which have a tendency to compromise the accuracy of readings due to linearity issues. Furthermore, it is understood that the Entellisys System lacks optimum inter-switchboard over current protective relaying coordination. As a result, the monitoring system does not have the ability to accurately identify abnormal systemic behavior and react accordingly. Such systems may not be sufficient for industrial use where critical reliance is placed in electrical power distribution systems.

In order to effectively monitor an electrical power distribution system it is absolutely critical to obtain the most accurate reading of electrical parameters on the system, including voltage, current, temperature, or the like. Precise measurement of electrical parameters facilitates the identification of root cause problems that lie within the system. Additionally, key infrastructure and vital instruments rely upon the electrical power distribution system at all times. As a result the monitoring system must be able to report the actions of protective devices in real time to indicate any abnormal activity, sub par performance, or electrical power distribution system deficiencies.

Therefore, there is currently a need in the art for a system and method for distributing power and monitoring an electrical power distribution system to precisely identify and pinpoint power failures in the power system. Additionally, it is desirable for the system to be cost effective, efficient, and a safe alternative to assess and control vital distribution systems.

### BRIEF SUMMARY

In accordance with the present invention, there is provided multiple embodiments of systems and methods for monitoring an electrical power distribution system. The system and methods provide a comprehensive monitoring system capable of accurately assessing system performance by identifying system interference and pinpointing power failures. The power distribution and monitoring system of the present invention is designed to capture various parameters capable of being monitored in an electrical power distribution system, such as voltage, current, temperature or the like. The system may have configurable settings to precisely identify various coordination settings of individual circuit breakers or collectively arranged circuit breakers. The system may be designed as embedded hardware that is installed throughout an electrical power distribution system.

A basic embodiment of the power distribution and monitoring system includes at least one switchboard with a circuit that includes a circuit breaker for interrupting power in a circuit path between a source and a load. Additionally, the system may include at least one phase line monitor communicatively coupled to the circuit for measuring electrical parameters on the line side of the circuit. In an alternative embodiment of the present invention, the system may include a breaker interface module. A breaker interface module is communicatively coupled to the circuit for measuring various electrical parameters on the load side of the circuit. It is contemplated that in order to adhere to space requirements, the phase line monitor preferably stores data in analog format and transfers such data to a corresponding breaker interface module. As such, the breaker interface module may include an analog to digital converter for facilitating the conversion of analog readings into digital signals for further processing. In this regard, the breaker interface module may further comprise a computer processor having memory to store digital data and being operative to run various software programs capable of performing electrical calculations upon the data.

The breaker interface module may include a data input for receiving data from various components of the system such as the phase line monitor and a wireless transmitter to transmit data via a conventional telecommunications modality, such as a proprietary system like Zigbee, Bluetooth, or radio signals, RFID, and the like and/or through conventional communications means such as the Internet. Data transferred from the breaker interface modules provides the key analytical data for remote monitoring of the electrical power distribution system.

In a preferred embodiment of the present invention, the phase line monitor and breaker interface module are configured to detect ground, and system voltage and current and transmit these readings to a control panel mounted in a panel board. It is contemplated that the breaker interface modules transmit data synchronously and time stamp events on the electrical power distribution system for future event logging and analysis. It is further contemplated that the breaker interface modules are an add-on device and may be coupled to existing power systems.

The control panel may be incorporated within the electrical power distribution system or alternatively it may be positioned outside of the system. One of the features of the control panel is to serve as a data repository to store data measured by the system. In this regard, the control panel may include a computer processor for storing data and a transmitter for transmitting data to a remote server for further system analysis and provide real time monitoring of the system to identify critical failures or deficiencies. The real time transmission of data provides the present system with a continuously updated status of the electrical power distribution system at any given time. It will be appreciated that such a configuration is advantageous over the prior art which requires monitoring systems to interrogate various system components to initiate a data transfers.

Detailed analysis and monitoring may be performed off site from the electrical power distribution through the remote server. The remote server is programmable with various software programs that assess and record system performance. As such, the remote server includes an input for receiving data from the control panel or other portions of the system. It is contemplated that the computer processor has memory to store data and a display for viewing the data.

The remote server may be programmable to run a variety of data tracking programs which are integrated as software programs and are operative to monitor and provide analysis on the system. Critical metrics assessed by the system include real time line side voltage and current, load side voltage, and temperature for calibration. Additionally, the remote server may identify any points of failure within the circuitry of the electrical power distribution system. It is contemplated that the remote server may be configured to identify peak times of peak uses of voltage and current in the system. The software of the remote server may be operative to provide a variety of system analysis, such as arc flash monitoring, phase balance monitoring, and the like.

Remote monitoring of an electrical power distribution system is an efficient and cost effective way to monitor a system. It is contemplated that present invention may generate an alert message based upon the real time parameters of the system. In one embodiment of the present invention, once an alert is triggered, the corresponding breaker interface module may be initiated to send data of the event that causing the alert. Users may configure the system for self monitoring equipment or tapping the resources of a provider, which has the capability of flagging and authenticating data sent from any location across the power system, and subsequently evaluating the data and notifying personnel to remedy the defective situation. In this regard, remote monitoring may identify abnormal conditions within the entire electrical power system as they develop, before a failure or significant damage can occur.

Further in accordance with the present invention, there is a method provided for acquiring electrical parameters from the line side and load side of a circuit. The method initiates by instructing the phase line monitor and breaker interface modules to make a ground reference. The method continues by measuring the line side and load side electrical parameters. Subsequently, the phase line monitor may be adapted to transfer data to the breaker interface module for digital conversion and further analysis. The method continues by compiling the data within the breaker interface module and performing calculations upon the data. Finally, the breaker interface module transfers the data to a remote server for further analysis and real time monitoring.

As will be appreciated, in addition to the convenience and enhanced accuracy afforded by the monitoring aspects of the present invention, there is further provided a system by which an electrical power distribution system can be monitored and assessed to ensure optimal performance and safety. The systems and methods can also be utilized to prevent harmful power overloads and remedy inefficient power depleting activities while facilitating the distribution of power.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 depicts a basic embodiment of the present invention illustrating a power distribution and monitoring system embedded as hardware within a conventional three phase electrical power distribution system;

FIG. 2 depicts an exemplary embodiment of the present invention where multiple phase line monitors synchronously transfer data to one breaker interface module;

FIG. 3 depicts an exemplary embodiment of the present invention where the phase line monitor is communicatively coupled to the line side and load side of the circuit to measure voltage and current in a miniature circuit breaker;

FIG. 4 depicts an exploded view of a breaker interface module and a phase line monitor illustrating the operative components that provide the functionality of each and how they correspond with each other;

FIG. 5 is a block diagram depicting a sequence of steps of acquiring data from the line side and load side of a power system and transferring the data to a remote server for further analysis and real time monitoring of the power system.

FIG. 6 is a block diagram illustrating an alternate embodiment of the invention wherein the breaker interface module and the phase line monitor are collectively constructed as a single module bridging line side and load side.

Common reference numerals are used throughout the drawings and detailed description to indicate like elements.

### DETAILED DESCRIPTION

The detailed description set forth below is intended as a description of the presently preferred embodiment of the invention, and is not intended to represent the only form in which the present invention may be constructed or utilized. The description sets forth the functions and sequences of steps for constructing and operating the invention. It is to be understood, however, that the same or equivalent functions and sequences may be accomplished by different embodiments and that they are also intended to be encompassed within the scope of the invention.

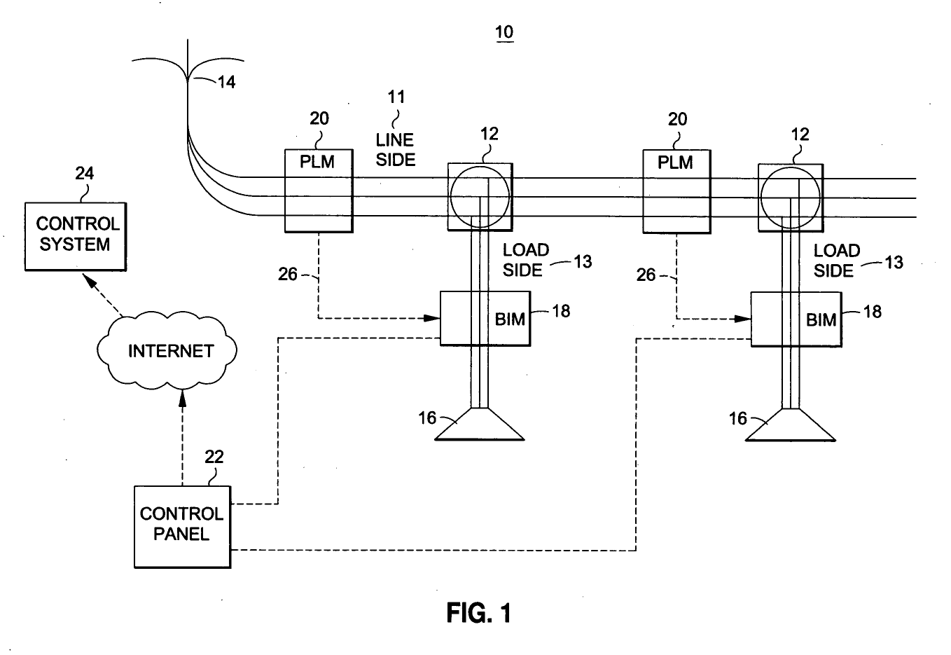

FIG. 1 depicts the power distribution and monitoring system 10 configured to be embedded within an electrical power distribution system in accordance with the present invention. In a basic embodiment of the present invention, the power distribution and monitoring system includes at least one circuit breaker 12 for interrupting power in a circuit path between a source 14 and a load 16. In this regard, the circuit breaker may be implemented as an automatically operated electrical switch designed to protect the load 16 from damage caused by overload or short circuit. Each circuit breaker 12 installed on the electrical power distribution system may be considered to be a node of the system.

The power distribution and monitoring system 10 monitors and analyzes various electrical parameters of the electrical power distribution system. The system 10 has configurable settings to accurately identify the coordination settings of each circuit breaker 12. Additionally, the system 10 is capable of having configurable settings for utilities fault current contribution at the service entrance point along with contributions from standby generators and large machinery. Therefore, the system 10 provides complete analysis of the entire system. Additionally, the system 10 is designed to monitor and detect electrical parameters from each source 14 of the system. Collectively, the system 10 provides a dynamic protective relaying coordination study using various electrical parameters such as voltage drop or the like, to determine any power reductions throughout the threads of the electrical power distribution system.

The system 10 may include at least one breaker interface module 18 (BIM) for measuring a variety of electrical parameters on the load side 13 of the electrical power distribution system and at least one phase line monitor 20 (PLM) for measuring a variety of electrical parameters on the line side 20A of the electrical power distribution system. Therefore, the PLM 20 and corresponding BIM 18 advantageously provide complete nodal analysis of the electrical power distribution system. It is contemplated that the present system 10 may be expandable to meet the needs of expanding electrical power distribution systems.

A phase line monitor 20 (PLM) is configured for measuring a variety of electrical parameters on the line side 11 such as voltage, current, temperature and the like. In a preferred embodiment of the present invention, the PLM 20 is configured to detect line side voltage and current. The PLM 20 is communicatively coupled to the circuit. In one embodiment of the present invention, the PLM 20 is affixed directly to the line bussing, for each circuit breaker 12, by utilizing two bolted connections. It is contemplated that the PLM 20 may be configured to detect voltage and current by utilizing conventional voltage sensors, hall effect sensors, giant magnetoresistors, and the like. However, a person having ordinary skill in the art will understand that a variety of sensors may be implemented in the PLM 20 to ascertain the parameters to be measured. In a preferred embodiment of the present invention, a PLM 20 is adapted to establish a connection 26 with a BIM 18 to transmit the parameters from acquired from the line side of the circuit to the BIM 18 for further analysis. In the present embodiment, the connection 26 is made via a cable. However, it is contemplated that any communication means, wired or wireless, may be utilized to transmit data between a PLM 20 and BIM 18.

It is further contemplated that the PLM 20 continuously monitors line side current and overall power quality within the electrical power distribution system. In this regard, the system 10 may be configured to continuously emit a predetermined amount of current for measurement. As such, in a preferred embodiment, the system 10 is configured to continuously emit 100,000 amps of current for detection and analysis. It is contemplated that the emission of 100,000 amps may be a short duration event of less than three cycles. A person having ordinary skill in the art will understand that any amount of current may suffice to continuously measure current depending on the requisite measuring capabilities and needs of the system. The density of the bus bar must be constructed to withstand the continuously sustainable currents.

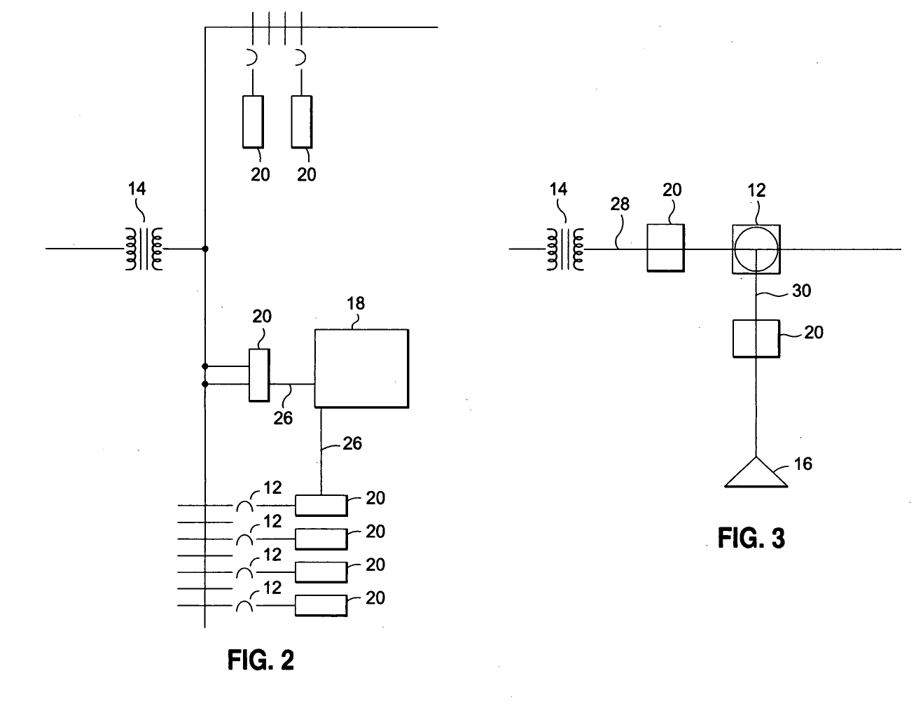

In a preferred embodiment of the present invention, the PLM 20 is employed within the smallest of electrical power distribution systems. In order to be space efficient, the electrical parameters acquired from the line side are in analog format and subsequently digitized within the BIM 18. It is further contemplated that the present system 10 may be configured so that there is a one to one relationship between each PLM 20 and BIM 18 within each node, as illustrated in FIG. 1. Alternatively, the system 10 may be configured so that there is a one to many relationship between the BIM 18 and multiple PLMs 20, as illustrated in FIG. 2. In this regard, the electrical parameters acquired from multiple PLMs 20 may be transmitted to one BIM 18 for data compilation. As such, each node of the system 10 may have a multitude of associated PLMs 20 on the line side measuring a variety of electrical parameters, and one corresponding BIM 18 on the load side for data compilation. Alternatively, one or more PLM 20 may communicate directly to the control panel 20, with data compilation/analysis being effected at the control panel or another remote location.

It is further contemplated that the present system 10 may be configured to adapt to conventional circuit breakers 12 or modified circuit breakers such as miniature circuit breakers. In this regard, the system 10 is configured relative to the size of the electrical power distribution system. FIG. 3 illustrates the system 10 configured so that a PLM 20 is utilized on both, the line side and load side of the circuit to obtain electrical parameters from each node, without use of a BIM 18. This configuration advantageously enables the system 10 to be utilized with a variety of components and employed within a variety of electrical power distribution systems. In such a configuration the control panel at the data may subsequently be compiled, digitized and analyzed at a remote location or within the system 10.

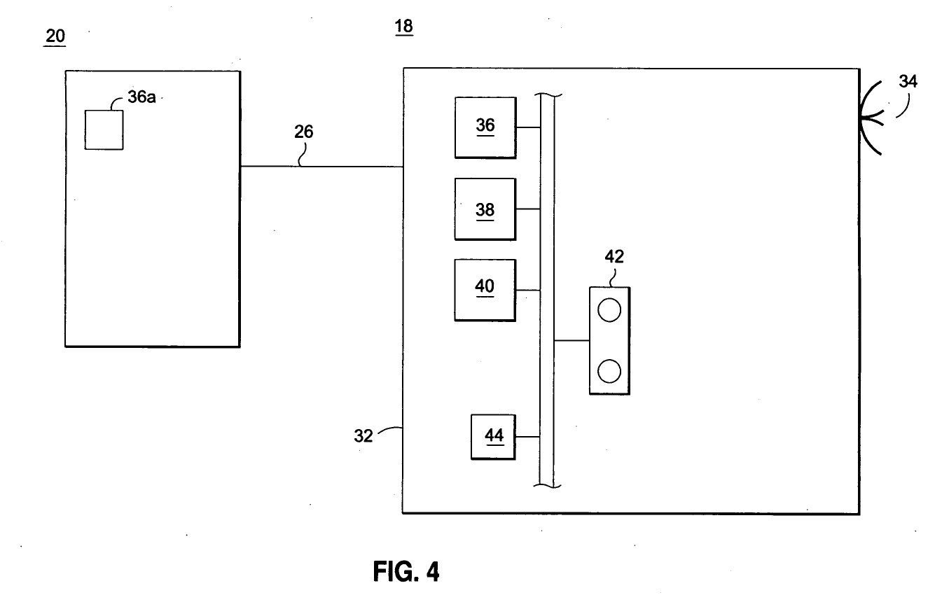

Now referring back to FIG. 1, a BIM 18 may be configured to detect any desired parameter from the load side such as voltage, current, temperature and the like. A BIM 18 is an add-on device that is communicatively coupled to the load side of each node. It is contemplated that the BIM 18 may be communicatively coupled to the circuit or the circuit breaker 12 via bus bar connectors, landing lugs, and the like. A person having ordinary skill in the art would understand that any conventional connector may rigidly connect the BIM 18 to the load side of the circuit such as ring-style lugs, Molex-style plugs, Phoenix-style terminal strips and the like. Now referring to FIG. 4, in the present embodiment a BIM 18 includes a housing 32 having an attachment device 34 configured for rigidly connecting to a the load side. It is contemplated that the housing 32 is fabricated from materials with high dielectric and mechanical properties to withstand the electrical and mechanical environments that may be encountered such as Lexan or the like.

Now referring to FIGS. 1 and 4, a BIM 18 and PLM 20 include data acquisition circuitry 36, 36a having a voltage and ground reference for measuring energy delivered to a connected load 16. It is contemplated that a variety of sensors may be utilized for measuring line side and load side voltages and line side current. In this regard, the data acquisition circuitry 36, 36a of the PLM and BIM may include at least one resistance network for measuring phase to phase voltage and phase to ground voltage.

Additionally, the data acquisition circuitry 36, 36a of the PLM 20 and the BIM 18 may include at least one Hall effect sensor for measuring phase and ground currents. A Hall effect sensor is a transducer that varies its output voltage in response to changes in magnetic field. Hall effect sensors are used for proximity switching, positioning, speed detection, and current sensing applications. In its simplest form, the sensor operates as an analogue transducer, directly returning a voltage. With a known magnetic field, its distance from the Hall plate can be determined. Using groups of sensors, the relative position of the magnet can be deduced. Electricity carried through a conductor will produce a magnetic field that varies with current, and a Hall sensor can be used to measure the current without interrupting the circuit. However, a person having an ordinary skill in the art will appreciate that voltage and current may be measured in a variety of ways and the above exemplary embodiments are not intended to limit the invention.

In an alternative embodiment of the present invention the data acquisition circuitry 36, 36a of the PLM and the BIM may further include at least one magnetoresistor for measuring a reading of the magnetic flux of the power system. Magnetoresistors are capable of measuring small electrical currents by measuring their magnetic properties. As a result, the system 10 is capable of measuring precise and accurate readings of magnetic flux in the power system enabling the system to identify and pinpoint areas of interference in the electrical power distribution system. Additionally, the quality of energy distributed in the electrical power distribution system is assessed. Prior art monitoring systems utilize transformers to measure current in a system. However, transformers are typically inaccurate in some ranges, as a result of linearity issues and are, therefore, incapable of providing the requisite level of analysis required to effectively monitor modern electrical power distribution systems. Additionally, in order to correctly align the transformer to gain an accurate reading, significantly more space is required. Therefore, prior art systems do not possess the adaptability to be employed within a variety of electrical power distribution systems. Additionally, the cost in correcting a poor transformer alignment is high since any correction would require a significant adjustment of the overall system.

In contrast, the present invention is capable of accurately detecting electrical parameters within a variety of electrical power distribution systems and further is designed to promote low cost maintenance. In this regard, the present invention overcomes the prior art systems linearity and reliability issues with the PLMs 20 which are individually biased and calibrated and therefore supply linearly accurate data of the measured spectrum upstream to the corresponding BIM 18. As such, a faulty PLM 20 may be replaced and calibrated without having to recalibrate the entire system 10. This not only promotes a prompt remedy of a faulty PLM 20 but allows the remainder of the system 10 to remain online during maintenance. Therefore, the remainder of the nodes are still monitored during the replacement of a faulty PLM 20.

In the present embodiment, the BIM 18 further includes computer processor 38 that is programmable to run a data algorithm program operative to accept, store, actively buffer data, and run electrical parameter calculations on the data. Additionally, the BIM 18 includes an analog to digital converter 40 for digitizing analog readings transmitted from the PLM 20 into digital data.

In a preferred embodiment of the present invention, the BIM 18 may include a high-speed recorder 42 for recording various event data, pre-event data, and post-event data in the system 10. As noted above, the BIM 18 is designed to continuously measure the load voltage of a node. As a result, the BIM 18 continuously evaluates waveforms in its internal buffer and compares those waveforms with preset thresholds. If a threshold has crossed the memory storage available in the BIM 18, the recorder 42 may begin to permanently record the event at some selectable time, e.g. at t=−s200 mS and continue for at least a one second duration (1000 mS) duration. The recorded event, pre-event and/or post-event data may be simultaneously transmitted across the network to the remote server 24 for analysis. Therefore, the system 10 is advantageously designed to continuously monitor the power quality of the electrical power distribution system despite any memory capacity issues. A person having ordinary skill in the art will understand that the recording cycles may be configured relative to the needs of the specific system and in this regard, timing parameters, e.g. pre-event or post-event data capture, may be adjusted accordingly.

In an alternative embodiment of the present invention, the BIM 18 may have preset critical thresholds, for any electrical parameter measured that if crossed, would trigger the recorder 42 to transmit all data prior to the event, during the event, and after the event for analysis. This feature advantageously identifies any anomalies within the system in real time and further promotes root-cause determination of issues as early as possible.

Furthermore, a BIM 18 may include a transmitter 44 for transmitting data to a control panel 22. It is contemplated, that the BIM 18 transmits data via any telecommunications modality, such as a proprietary system like ZigBee, Bluetooth, or radio signals, RFID, and the like, may be utilized as the method of communications of the present invention. In a preferred embodiment, the method of communications in the system 10 is ZigBee to Ethernet switch/router. ZigBee is a high level communication protocols using small, low-power digital radios based on 802.15.4 standard for wireless personal area networks (WPANs), such as wireless headphones connecting with cell phones via short-range radio. The technology has a lower cost than other WPANs, such as Bluetooth. ZigBee is targeted at radio-frequency applications that require a low data rate, long battery life, and secure networking. ZigBee is a low-cost, low-power, wireless mesh networking standard. The low cost allows the technology to be widely deployed in wireless control and monitoring applications, the low power-usage allows longer life with smaller batteries, and the mesh networking provides high reliability and larger range. However, it is contemplated that data may also be transferred via a conventional cable, such as a 600V jacketed twisted pair wire or the like.

In the present embodiment, the control panel 22 is mounted in a conventional panel board utilized by the electrical power distribution system. However, in an alternative embodiment of the present invention, the control panel 22 may be at a remote location. The control panel 22 may include a computer processor for storing data and a transmitter for transmitting data to a remote server 24 configured to provide analysis on the parameter of the system and monitor the system in real time. It is contemplated that the control panel 22 may be programmed to perform calculations and analysis on the data received from the various BIMs 20 and PLMs 18 of each node of the system. The distribution of data storage, data compilation and data analysis functions, between the PLM 20, BIM 18, control panel 22 and remote server 24, may be varied in accordance with the practicalities of particular systems, particular locations and other factors.

In a preferred embodiment, the control panel 22 transmits data to a remote server 24 for further analysis and monitoring. A person having ordinary skill in the art will appreciate that any data communications network may be utilized to transfer data from the control panel 22 to the remote server 24 such as an intranet operating in tandem with a proprietary network or the Internet and the like. The remote server 24 may include an input for receiving data from the control panel 22, a computer processor having memory to store the data and being operative to run software programs, and a display for viewing the data. The computer processor is programmable to run a variety of data tracking programs operative to monitor the system 10 in real time and provide further analysis on system 10 parameters such as the line phase voltage and current and load phase voltage and the like. Additionally, it is contemplated that the remote server 24 is configured to identify a point of failure within the circuitry of the electrical power distribution system in real time. Additionally the remote system 24 may be designed to identify peak times of peak uses of phase voltages in the system, thereby ensuring the electrical power distribution system is efficiently utilized. In this regard, the remote server 24 may further include an output device capable of generating a cognizable output (i.e. an alarm) upon a specific data parameter.

In a preferred embodiment of the present invention, the remote server 24 is capable of providing a diverse set of critical applications for monitoring the system 10 and the overall electrical power distribution system. Upon retrieving the electrical parameters, the remote server 24 applies computational algorithms including vector based calculations to obtain a variety of parameters, such as Frequency, Real Power (P), Reactive Power (Q), Apparent Power (S), and power factor in percentage, leading and lagging and the like.

In this regard, the remote server 24 may also provide proactive event maintenance by analyzing the quantitative data to support the root-cause analysis of power quality related failures of electrical loads. It is contemplated that the remote server 24 may be adapted to trigger a low current alarm threshold such that event logging is performed in relation to connected equipment failures. Low current threshold monitoring may require configuring the system 10 to monitor whether the current supplied to a particular piece of equipment has decayed to zero when the other equipment fed by the related electrical power distribution system have remained in service. E.g., this would be indicative of a fatal component failure. Additionally, the remote server 24 may monitor whether the current supplying a particular piece of equipment has decayed below a threshold but remained greater than zero. This could be indicative of a potential mechanical interface failure such as when motor belts driving a fan or pump have broken. The motor could continue to operate but the load could be decreased due to the broken fan belts. The event logging can provide summarized notices suggesting the possible root cause for circuit breaker 12 “nuisance” tripping events.

Additionally, comprehensive analytical data will be available to operations and maintenance personnel to enable determination of the actual cause of trip so that remedies can be implemented prior to restoration of power to a failed node or circuit. The prior art addresses the restoration of power to a circuit that has experienced a “nuisance” trip event by simply re-closing the circuit breaker 12 and observe the results. This method presents significant peril to the operator/maintenance personnel that are performing actions without sufficient data to support those actions that can potentially result in catastrophic failures for the electrical power distribution system and the personnel.

Additionally, it is contemplated that the remote server 24 may be adapted to provide power provider services. In this regard, electrical engineering services may be enabled with remote data interfaces to the present system to provide enhanced support of mission critical facilities for clients. The monitoring and adaptive communications modalities as employed in the system 10 are far advantageous over existing monitoring platforms. Furthermore, the system 10 provides an effective low cost alternative for users.

It is further contemplated that the system 10 may be adapted for use as predictive maintenance for circuit breakers 12 affected by over current events. In this regard, the remote server 24 will be able to report quantitative data regarding the amount of current and time of exposure to make qualitative determinations of circuit breakers' 12 conditions and abilities to continue to perform at operational effectiveness. The event logging features will provide summarized notices suggesting the possible root cause for breaker “nuisance” tripping events. Additionally, the comprehensive analytical data is available to operations and maintenance personnel to enable determination of the actual cause of trip so that remedies can be implemented prior to restoration of power to a failed circuit. As will be appreciated, the present system provides a safe alternative to the prior art systems in use. Furthermore, remedying a failed circuit requires less time as the root problems are readily identifiable.

The remote server is capable or providing a multitude of versatile features that may be incorporated into dynamic applications. In this regard, the remote server 24 may be adapted to provide integrated methods of tenant sub metering. Specifically, the remote server 24 assesses system 10 data to provide an accurate and precise reading from individual sensors to provide revenue-grade metering accuracy. Additionally, it is contemplated that rental rates may be modified to based upon a precise calculations of watts per square foot of occupied floor space.

It is further contemplated that the present invention may be employed with any “alternative power source” or mature technologies that may suffer from the lack of updated technology, wear and tear or misapplication, such as a solar panel system that reintroduces power into a power system and the like. Prior art alternative power systems may be lacking in their ability to accurately estimate and measure the quality of power redistributed into the system for use. However, it is contemplated that the present system may advantageously monitor the quality and accurately measure the amount of power generated and subsequently create event oriented detailed reports indicating the adequacy of performance.

In a preferred embodiment of the present invention, the remote server 24 will have the capability to monitor arc flash signature waveforms throughout the system. Additionally, the remote server 24 monitors phase imbalance conditions to ensure that current loss is monitored. Current loss equates to potential overheating connections of conductors as well as grounded or arcing conductor conditions. As a result, the remote server 24 may employ simple vector addition of current out≠current in of the downstream device to determine the level of reaction necessary. The remote server may be configured to display a phasor vector-based representation of the poly-phase electrical power circuits and phasor waveform-based representation of both individual and multiple phases of the poly-phase electrical power circuits. Thereby analyzing the interaction between multiple related circuits to demonstrate the interaction found throughout the entire electrical power distribution system.

As a result, the hardware elements may be configured to mount in place of the existing inter-cell jumpers to provide differential voltage and current monitoring. Therefore, the remote server 24 may be adapted to reflect the differential voltages of a string of battery cells to enable variance threshold alarming as well as performance characteristic analytical monitoring/reporting. Additionally, the hardware may have the ability to discern the frequency of the source voltage, whether DC or AC. Furthermore, the hardware may be able to monitor DC circuits and report harmonics due to load considerations or implications, poor or inefficient generation techniques, or system environmental effects.

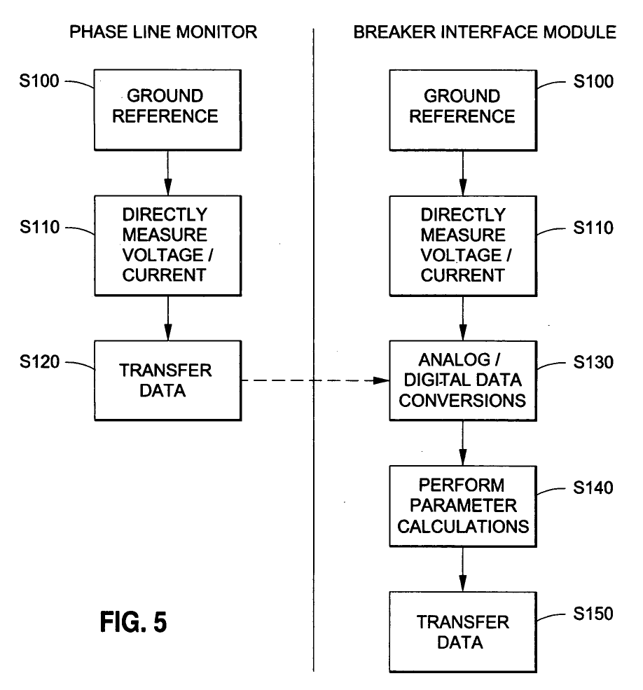

Further in accordance with the present invention, there is a provided a method for monitoring an electrical power distribution system. FIG. 5 is a block diagram depicting a sequence of steps for acquiring data from the line and load sides of an electrical power distribution system and transferring the electrical parameters to a remote server. Now referring to FIGS. 1 and 5, the method initiates S100 by instructing the PLM 20 and BIM 18 to make a ground reference. The method continues S110 by measuring the line side current and voltage along with the load side voltage of each node of the system. In this regard, the PLM 20 measures the line side voltage and current and subsequently transfers the data to a corresponding BIM 18 at S120. The method continues S130 by the BIM 18 converting the analog data provided by the PLM 20 into digital data. Subsequently, S140 the BIM 18 performs calculations upon the electrical parameters of the system 10. Finally, S150 the BIM 18 transfers the data to a remote server 24 for real time nodal analysis and remote monitoring of the system 10.

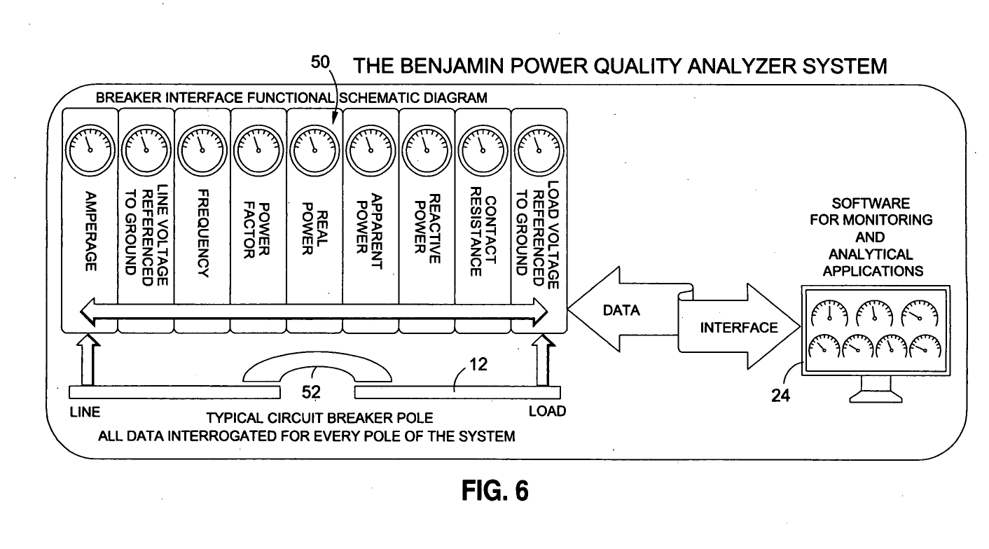

FIG. 6 illustrates an alternate implementation of the invention wherein the PLM 20 and BIM 18 are collectively constructed as a single module 50, connected to span line side and load side across a circuit breaker pole 52. The module 50 senses conditions on the line side and load side, and may compile and analyze the sensed data to derive information such as amperage, line voltage reference to ground, frequency, power factor, real power, apparent power, reactive power, contact resistance, load voltage reference to ground and other information. The module 50 may interface with the remote server 24, either directly or via a control panel 22.

As would be recognized by those skilled in the art, the particular construction of PLM 20 and BIM 18, as discrete modules or as a combined module, such as module 50, may be selected based on factors such as the maturity or location of the power distribution system, the physical arrangement of the system, available space within system components, desired performance and monitoring functions, and other factors. However, whether the system is formed as separate components, or collectively formed as a single module, the basic functionality of the system remains as previously described.

Additional modifications and improvements of the present invention may also be apparent to those of ordinary skill in the art. Thus, the particular combination of parts and steps described and illustrated herein is intended to represent only certain embodiments of the present invention, and is not intended to serve as limitations of alternative devices and methods within the spirit and scope of the invention.

What is claimed is:

1. A power distribution and monitoring system having a source that provides electrical power to a load, comprising:
a switchboard having at least one circuit breaker for interrupting power in a circuit path between a source and a load;
at least one line monitor in electrical communication with the switchboard, for continuously measuring line voltages and line currents on the switchboard;
at least one load monitor in electrical communication with the switchboard, for continuously measuring, storing, and buffering load voltages of the switchboard.

2. The power distribution system of claim 1, wherein the load monitor further includes:
a data input for receiving electrical parameters from the line monitor;
an analog to digital converter for converting the electrical parameters into digital data;
a computer processor being operative to run a software program for performing calculations upon the data; and
a data output being operative to transmit the digital data to a remote server.

3. The power distribution system of claim 1, wherein the line monitor measures phase to phase line voltage and phase to ground line voltage.

4. The power distribution system of claim 2, wherein the load monitor transmits the data to the remote server via a wireless network.

5. The power distribution system of claim 2, wherein the remote server is programmable for running software that monitors the electrical parameters of the system in real time.

6. The power distribution system of claim 1, wherein the load monitor further includes a recorder for recording a system event and system pre event.

7. The power distribution system of claim 6, wherein the recorder is initiated to record the system event and system pre event when the load monitor runs out of memory for a predetermined amount of time.

8. The power distribution system of claim 6, wherein the recorder is initiated to record the system event and system pre event when the load monitor reaches a threshold buffer capacity for a predetermined amount of time.

9. The power distribution system of claim 6, wherein the recorder transmits the system event and system pre event data to the remote server.

10. The power distribution system of claim 1, wherein the source is configured to continuously emit 100,000 amps of current for the line monitor to continuously measure.

11. The power distribution system of claim 10, wherein the remote server is configured to monitor the continuously emitted current in real time.

12. The power distribution system of claim 1, wherein the line monitor includes a hall effect sensor for measuring system currents.

13. The power distribution system of claim 1, wherein the line monitor further includes a magnetoresistor for measuring a reading of the magnetic flux of the power system.

14. The power distribution system of claim 2, wherein the load monitors are configured to transmit data to a remote server synchronously.

15. The power distribution system of claim 14, wherein the load monitor transmits the data to a control panel mounted on the switchboard via a wireless network.

16. The power distribution system of claim 15, wherein the control panel transmits the data to the remote server via the Internet.

17. The power distribution system of claim 1, wherein the line monitors are configured to measure the electrical parameters on the line and load side of the circuit.

18. A method for monitoring a power system, the method comprising the steps of:
a. measuring a plurality of electrical parameters on the line side of the system with at least one line monitor;
b. measuring a plurality of electrical parameters on the load side of system with at least one load monitor;
c. transferring the analog electrical parameters from the line monitor to the load monitor;
d. running a software program stored in the load monitor to perform calculations on the data;
e. transmitting the data from the load monitor to a control panel mounted in a switchboard; and
f. transmitting the data from the control panel to a remote server for remote monitoring of the system in real time.

19. The method of claim 18, wherein step (a) continuously measures the line voltage and current of the system.

20. The method of claim 18, wherein step (b) continuously measures the load voltage of the system.
